(19) United States
(12) Patent Application Publication
(10) Pub. No.: US 2021/0333587 A1
(43) Pub. Date: Oct. 28, 2021

(54) DISPLAY PANEL MOTHERBOARD AND LIQUID CRYSTAL DISPLAY PANEL

(71) Applicant: TCL China Star Optoelectronics Technology Co., LTD., Shenzhen, Guangdong (CN)

(72) Inventor: Weiji ZHANG, Shenzhen (CN)

(21) Appl. No.: 16/617,158

(22) PCT Filed: Nov. 14, 2019
(86) PCT No.: PCT/CN2019/118252

§ 371 Date: Nov. 26, 2019

(30) Foreign Application Priority Data
Sep. 19, 2019 (CN) 201910886185.3

(51) Int. Cl. G02F 1/1339

(52) U.S. Cl. CPC G02F 1/1339; G02F 1/133351

(57) ABSTRACT

A display panel motherboard and a liquid crystal display panel are provided. The display panel motherboard includes the liquid crystal display panel. The liquid crystal display panel includes an array substrate, a color filter substrate, a sealant, and a retaining wall structure. The retaining wall structure includes a first retaining wall and a second retaining wall spaced apart with each other, the first retaining wall is disposed around a display area of the liquid crystal display panel, the second retaining wall is disposed around the first retaining wall, and the sealant is disposed around the display area and positioned between the first retaining wall and the second retaining wall.

### FIELD OF INVENTION

The present disclosure relates to the field of display technologies, and more particularly to a display panel motherboard and a liquid crystal display panel.

### BACKGROUND OF INVENTION

At present, narrow bezel panels are increasingly being used in technologies associated with narrow bezel televisions (TVs), borderless TVs, and splicing screens. In production of liquid crystal display panels, current sealant coating is usually applied by a pneumatic coating method. For the sealant coating having a sealant width of 500 μm or less, it is difficult to ensure coating stability, and it is difficult to achieve sealant width control.

### SUMMARY OF INVENTION

An embodiment of the present application provides a display panel motherboard including at least two liquid crystal display panels arranged in an array. Each liquid crystal display panel comprises an array substrate, a color filter substrate, a sealant and a retaining wall structure both disposed between the color filter substrate and the array substrate. The retaining wall structure includes a first retaining wall and a second retaining wall spaced apart with each other, the first retaining wall is disposed around a display area of the liquid crystal display panel, the second retaining wall is disposed around the first retaining wall, the sealant is disposed around the display area and positioned between the first retaining wall and the second retaining wall, and the first retaining wall and the second retaining wall are formed by inkjet printing.

An embodiment of the present application provides a display panel motherboard including at least two liquid crystal display panels arranged in an array. Each liquid crystal display panel comprises an array substrate, a color filter substrate, a sealant and a retaining wall structure both disposed between the color filter substrate and the array substrate. The retaining wall structure includes a first retaining wall and a second retaining wall spaced apart with each other, the first retaining wall is disposed around a display area of the liquid crystal display panel, the second retaining wall is disposed around the first retaining wall, and the sealant is disposed around the display area and positioned between the first retaining wall and the second retaining wall.

In an embodiment of the present application, the first retaining wall is a continuous structure, and the first retaining wall is in contact with the array substrate and the color filter substrate.

In an embodiment of the present application, the second retaining wall is a discontinuous structure, and the second retaining wall is provided with at least one opening extending through an inner side and an outer side of the second retaining wall.

In an embodiment of the present application, a number of the at least one opening is plural.

In an embodiment of the present application, a longitudinal section of the at least one opening is entirely rectangular.

In an embodiment of the present application, a longitudinal section of the at least one opening is entirely funnel-shaped, flared-shaped, or hourglass-shaped.

In an embodiment of the present application, the liquid crystal display panel is provided with a cutting area surrounding the display area, and an orthographic projection of the second retaining wall on the array substrate comprises an orthographic projection of a corresponding cutting area on the array substrate.

In an embodiment of the present application, in a case where a longitudinal section of the at least one opening is rectangular, the cutting area corresponds to any portion of the at least one opening; and in a case where the longitudinal section of the at least one opening is funnel-shaped, flared-shaped, or hourglass-shaped, the cutting area corresponds to a smallest width of the at least one opening.

An embodiment of the present application provides a liquid crystal display panel. The liquid crystal display panel comprises an array substrate, a color filter substrate, a sealant and a retaining wall structure both disposed between the color filter substrate and the array substrate. The retaining wall structure includes a first retaining wall and a second retaining wall spaced apart with each other, the first retaining wall is disposed around a display area of the liquid crystal display panel, the second retaining wall is disposed around the first retaining wall, and the sealant is disposed around the display area and positioned between the first retaining wall and the second retaining wall.

In embodiment of the present application, the first retaining wall is a continuous structure, the first retaining wall is in contact with the array substrate and the color filter substrate, the second retaining wall is a discontinuous structure, and the second retaining wall is provided with at least one opening extending through an inner side and an outer side of the second retaining wall.

Beneficial effects of an embodiment of the present application are that, by controlling the interval between the first retaining wall and the second retaining wall, sealant width control of the sealant is realized, which is convenient and simple, has high stability, overcomes issues of cutting splits caused by insufficient uniformity of the sealant width in the display panel having the narrow sealant width. Use of current pneumatic frame coating process can still achieve stable production of narrow sealant width products.

### DESCRIPTION OF DRAWINGS

In order to more clearly illustrate the technical solutions in the embodiments of the present application, the drawings used in the description of the embodiments will be briefly described below. It is obvious that the drawings in the following description are only some embodiments of the present application. Other drawings can also be obtained from those skilled in the art based on these drawings without paying any creative effort.

FIG. 1 is a schematic structural view of a display panel motherboard according to an embodiment of the present invention.

FIG. 2 is a schematic view showing a distribution of liquid crystal display panels on a display panel motherboard according to an embodiment of the present invention.

FIG. 3 is a schematic structural view of a retaining wall structure according to a second embodiment of the present invention.

FIG. 4 is a schematic structural view of a retaining wall structure according to a third embodiment of the present invention.

FIG. 5 is a schematic structural view of a retaining wall structure according to a fourth embodiment of the present invention.

FIG. 6 is a schematic structural view of a liquid crystal display panel according to an embodiment of the present invention.

FIG. 7 is a schematic structural view of a retaining wall structure of a liquid crystal display panel according to an embodiment of the present invention.

### REFERENCE NUMERALS

10, liquid crystal display panel; 11, array substrate; 12, color filter substrate; 13, liquid crystal layer; 14, retaining wall structure; 141, first retaining wall; 142, second retaining wall; 1421, opening; 16, display area; 20, cutting area; 30, spacer.

### DETAILED DESCRIPTION OF PREFERRED EMBODIMENTS

The following description of the various embodiments is provided to illustrate the specific embodiments of the present invention. Directional terms mentioned in the present invention, such as upper, lower, front, rear, left, right, inside, outside, side, etc., are merely directions referring to the drawings. Therefore, the directional terminology used is for the purpose of illustration and understanding of the present invention. In the drawings, structurally similar elements are denoted by the same reference numerals.

Current liquid crystal display panels are difficult to achieve a sealant width control when a narrow sealant width of a sealant is formed by a pneumatic coating method. An embodiment of the present invention can solve the above issues.

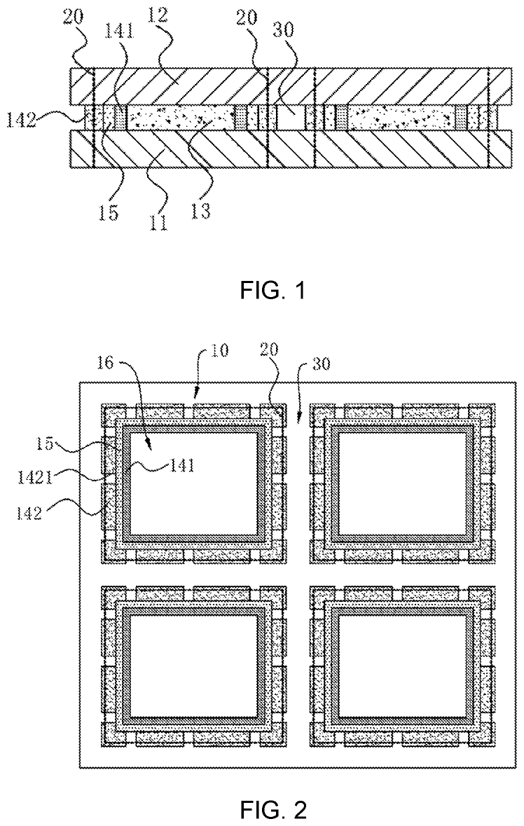

As shown in FIG. 1 and FIG. 2, a display panel motherboard includes at least two liquid crystal display panels 10 arranged in an array, and each of the liquid crystal display panels 10 includes an array substrate 11, a color filter substrate 12, and a sealant 15, a liquid crystal layer 13, and a retaining wall structure 14 all disposed between the color filter substrate 12 and the array substrate 11.

The liquid crystal layer 13 is disposed in a display area 16 of the liquid crystal display panel 10. The retaining wall structure 14 includes a first retaining wall 141 and a second retaining wall 142 disposed spaced apart with each other. The first retaining wall 141 is disposed around the display area 16 of the liquid crystal display panel 10, the second retaining wall 142 is disposed around the first retaining wall 141, and the sealant 15 is disposed around the display area 16 and positioned between the first retaining wall 141 and the second retaining wall 142.

The first retaining wall 141 and the second retaining wall 142 are formed at an interval on both sides of a sealant design position on the array substrate 11 or the color filter substrate 12. By filling glue into the interval between the first retaining wall 141 and the second retaining wall 142, the glue is solidified to form the sealant 15. By controlling the interval between the first retaining wall 141 and the second retaining wall 142, sealant width control of the sealant 15 is realized, which is convenient and simple, has high stability, overcomes issues of cutting splits caused by insufficient uniformity of the sealant width in the display panel having the narrow sealant width. Use of current pneumatic frame coating process can still achieve stable production of narrow sealant width products.

It should be noted that only the display panel motherboard includes four liquid crystal display panels 10 in FIG. 2. In actual implementation, the display panel motherboard may further include two, three, or even more liquid crystal display panels 10.

It should be noted that the first retaining wall 141 and the second retaining wall 142 may be formed by inkjet printing, or may be formed by stacking a film layer or the like.

Specifically, the first retaining wall 141 is a continuous structure, and the first retaining wall 141 is in contact with the array substrate 11 and the color filter substrate 12, thereby, the sealant 15 is sealed to prevent penetration of the sealant 15 from affecting display performance of the display area 16.

Specifically, the second retaining wall 142 is a discontinuous structure, and the second retaining wall 142 is provided with at least one opening 1421 extending through an inner side and an outer side of the second retaining wall 142.

Excess glue is overflowed from the opening 1421 through the opening 1421 provided in the second retaining wall 142, thereby avoiding the glue affecting pressing when the array substrate 11 and the color filter substrate 12 are pressed together, and at the same time, narrow sealant width cutting and splitting are facilitated.

Further, the opening 1421 has a width of 30 to 250 micrometers.

Further, the opening 1421 is provided in plurality.

In an embodiment, a spacing between adjacent openings 1421 is greater than 2 mm.

In an embodiment, four sides of the second retaining wall 142 are provided with openings 1421, and the openings 1421 are distributed around a circumferential side of the display area 16.

It should be noted that two or more openings 1421 may be disposed on each side of the second retaining wall 142, or one opening 1421 may be disposed on each side of the second retaining wall 142, and the opening 1421 is located at a middle of the side of the second retaining wall 142.

It should be noted that, in actual implementation, the opening 1421 may be disposed only on one or two or three sides of the second retaining wall 142.

It should be noted that the distribution of the openings 1421 may be uniformly distributed or non-uniformly distributed, and may be selected according to actual conditions.

In an embodiment, a number of the openings 1421 on one side of the second retaining wall 142 is 310.

It should be noted that, in actual implementation, the number of the openings 1421 on one side of the second retaining wall 142 may be more or less.

In an embodiment, a density of the openings 1421 near a corner of the second retaining wall 142 is greater than a density of the openings 1421 at other regions.

In a first embodiment, a longitudinal section of the opening 1421 is entirely rectangular.

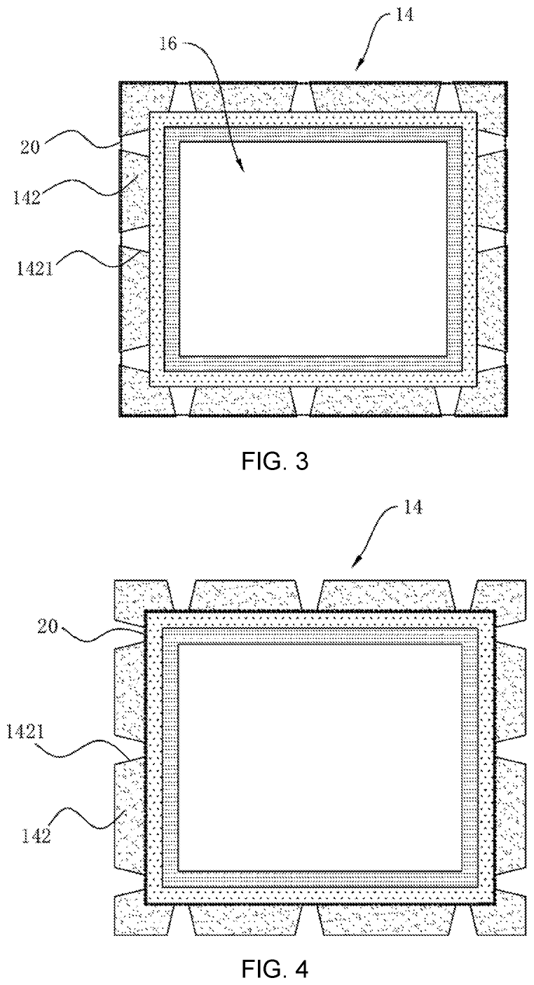

In a second embodiment, as shown in FIG. 3, the longitudinal section of the opening 1421 is entirely funnel-shaped.

In a third embodiment, as shown in FIG. 4, the longitudinal section of the opening 1421 is entirely flared-shaped.

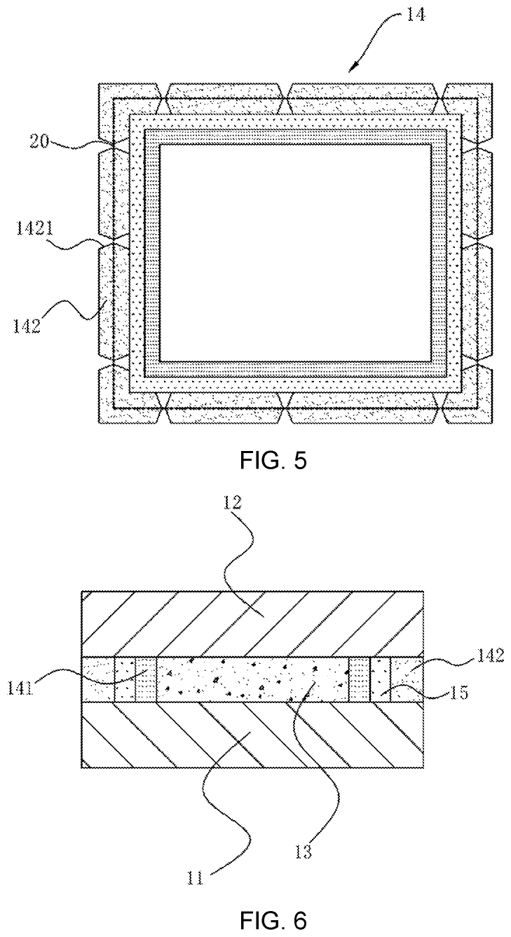

In a fourth embodiment, as shown in FIG. 5, the longitudinal section of the opening 1421 is entirely hourglass-shaped.

It should be noted that, in a specific implementation, the longitudinal section of the opening 1421 may also be other shapes, such as a trapezoidal shape, a semi-elliptical shape, a semi-circular shape, or a large semi-circular shape, which are not enumerated here.

Specifically, the liquid crystal display panel 10 is provided with a cutting area 20 surrounding the display area 16, and a spacer 30 is formed between two adjacent cutting areas 20. An orthographic projection of the second retaining wall 142 on the array substrate 11 includes a corresponding orthographic projection of the cutting area 20 on the array substrate 11.

Cut lobes are cut along the cutting area 20 on the display panel motherboard to form a plurality of independent liquid crystal display panels 10. By defining the position of the cutting area 20, it is convenient to cut and split along the cutting area 20, reduce splinter failure, and improve production yield.

In an embodiment of the present application, in a case where a longitudinal section of the at least one opening 1421 is rectangular, the cutting area 20 corresponds to any portion of the at least one opening 1421; and in a case where the longitudinal section of the at least one opening 1421 is funnel-shaped, flared-shaped, or hourglass-shaped, the cutting area 20 corresponds to a smallest width of the at least one opening 1421.

It should be noted that, in actual implementation, the cutting area 20 may also correspond to any position of the opening 1421.

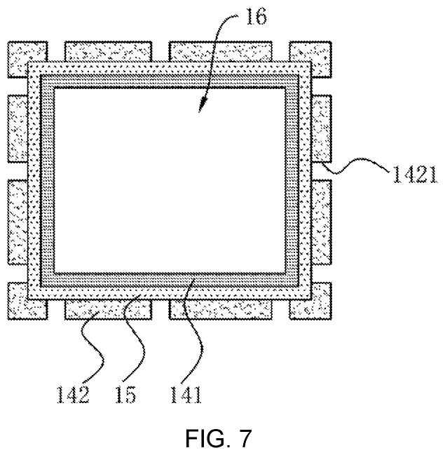

Based on the above display panel motherboard, an embodiment of the present invention also provides the liquid crystal display panel 10 which is formed by cutting the display panel motherboard along the cutting area 20 as shown in FIG. 6 and FIG. 7.

Specifically, the liquid crystal display panel 10 has the display area 16, and the liquid crystal display panel 10 includes the array substrate 11, the color filter substrate 12, and the sealant 15 and the retaining wall structure 14 disposed between the color filter substrate 12 and the array substrate 11.

The retaining wall structure 14 includes a first retaining wall 141 and a second retaining wall 142 disposed spaced apart with each other. The first retaining wall 141 is disposed around the display area 16 of the liquid crystal display panel 10, the second retaining wall 142 is disposed around the first retaining wall 141, and the sealant 15 is disposed around the display area 16 and positioned between the first retaining wall 141 and the second retaining wall 142.

Specifically, the first retaining wall 141 is a continuous structure, and the first retaining wall 141 is in contact with the array substrate 11 and the color filter substrate 12. The second retaining wall 142 is a discontinuous structure, and the second retaining wall 142 is provided with at least one opening 1421 extending through an inner side and an outer side of the second retaining wall 142.

Further, the opening 1421 has a width of 30 to 250 micrometers.

Further, the openings 1421 are distributed around a circumference of the display area 16, and a spacing between the adjacent openings 1421 is greater than 2 mm.

Beneficial effects of an embodiment of the present application are that, by controlling the interval between the first retaining wall 141 and the second retaining wall 142, sealant width control of the sealant 15 is realized, which is convenient and simple, has high stability, overcomes issues of cutting splits caused by insufficient uniformity of the sealant width in the display panel having the narrow sealant width. Use of current pneumatic frame coating process can still achieve stable production of narrow sealant width products.

In the above, the present invention has been disclosed in the above preferred embodiments, but the preferred embodiments are not intended to limit the present application. Various changes and modifications can be made by those skilled in the art without departing from the spirit and scope of the present invention. The protection scope of the present invention is therefore defined by the claims.

What is claimed is:

1. A display panel motherboard, comprising at least two liquid crystal display panels arranged in an array, wherein each liquid crystal display panel comprises:
an array substrate;
a color filter substrate;
a sealant and a retaining wall structure both disposed between the color filter substrate and the array substrate;
wherein the retaining wall structure comprises a first retaining wall and a second retaining wall spaced apart with each other, the first retaining wall is disposed around a display area of the liquid crystal display panel, the second retaining wall is disposed around the first retaining wall, the sealant is disposed around the display area and positioned between the first retaining wall and the second retaining wall, and the first retaining wall and the second retaining wall are formed by inkjet printing.

2. A display panel motherboard, comprising at least two liquid crystal display panels arranged in an array, wherein each liquid crystal display panel comprises:
an array substrate;
a color filter substrate;
a sealant and a retaining wall structure both disposed between the color filter substrate and the array substrate;
wherein the retaining wall structure comprises a first retaining wall and a second retaining wall spaced apart with each other, the first retaining wall is disposed around a display area of the liquid crystal display panel, the second retaining wall is disposed around the first retaining wall, and the sealant is disposed around the display area and positioned between the first retaining wall and the second retaining wall.

3. The display panel motherboard according to claim 2, wherein the first retaining wall is a continuous structure, and the first retaining wall is in contact with the array substrate and the color filter substrate.

4. The display panel motherboard according to claim 3, wherein the second retaining wall is a discontinuous structure, and the second retaining wall is provided with at least one opening extending through an inner side and an outer side of the second retaining wall.

5. The display panel motherboard according to claim 4, wherein a number of the at least one opening is plural.

6. The display panel motherboard according to claim 4, wherein a longitudinal section of the at least one opening is entirely rectangular.

7. The display panel motherboard according to claim 4, wherein a longitudinal section of the at least one opening is entirely funnel-shaped, flared-shaped, or hourglass-shaped.

8. The display panel motherboard according to claim 6, wherein the liquid crystal display panel is provided with a cutting area surrounding the display area, and an orthographic projection of the second retaining wall on the array substrate comprises an orthographic projection of a corresponding cutting area on the array substrate.

9. The display panel motherboard according to claim 8, wherein in a case where a longitudinal section of the at least one opening is rectangular, the cutting area corresponds to any portion of the at least one opening; and in a case where the longitudinal section of the at least one opening is funnel-shaped, flared-shaped, or hourglass-shaped, the cutting area corresponds to a smallest width of the at least one opening.

10. A liquid crystal display panel, comprising:
an array substrate;
a color filter substrate;
a sealant and a retaining wall structure both disposed between the color filter substrate and the array substrate;
wherein the retaining wall structure comprises a first retaining wall and a second retaining wall spaced apart with each other, the first retaining wall is disposed around a display area of the liquid crystal display panel, the second retaining wall is disposed around the first retaining wall, and the sealant is disposed around the display area and positioned between the first retaining wall and the second retaining wall.

11. The liquid crystal display panel according to claim 10, wherein the first retaining wall is a continuous structure, the first retaining wall is in contact with the array substrate and the color filter substrate, the second retaining wall is a discontinuous structure, and the second retaining wall is provided with at least one opening extending through an inner side and an outer side of the second retaining wall.
